(19) United States
(12) Patent Application Publication
(10) Pub. No.: US 2005/0122314 A1
(43) Pub. Date: Jun. 9, 2005

(54) Hand-held electronic device

(76) Inventors: Chia-Hung Chen, Lujhou City (TW); I-Hsuan Chen, Taipei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/989,962

(22) Filed: Nov. 16, 2004

(30) Foreign Application Priority Data
Dec. 5, 2003 (TW) 92134470
Feb. 27, 2004 (TW) 93105223

(51) Int. Cl. G09G 3/18; G09G 5/00

(52) U.S. Cl. 345/169

(57) ABSTRACT

A hand-held electronic device with calculation operating functions, including a main body, a plurality of number keys disposed on the main body, a display, and at least M operation keys, is disclosed. The display is used for displaying an operation indicator area, a highlight, and a numeral area. Operation indicator area includes N operator indicators arranged in M directions around the reference point. The highlight is used to indicate the selected operator indicator. Numeral area is used to display various numbers. M operation keys are respectively corresponding to M directions of the operator indicators. As one of the M operation keys is triggered, the highlight shifts along the corresponding direction to choose the operator indicator and to perform the corresponding operating functions.

This application claims the benefit of Taiwan applications Serial No. 92134470, Dec. 5, 2003, and Serial No. 93105223, filed Feb. 27, 2004, the subject matter of which is incorporated herein by reference.

### BACKGROUND OF THE INVENTION

1. Field of the Invention

The invention relates to a hand-held electronic device, and more particularly to a hand-held electronic device with calculation functions.

2. Description of the Related Art

For traditional desktop calculators, to obtain a calculation result, a user only needs to press functional buttons, besides the number keys, up to a maximum of two times. A consecutive calculation of addition, subtraction, multiplying or dividing in each operation requires only one-time operation with no need of inserting any equal signs. However, as to mobile phones, most people prefer simplified functional designs due to the limited functional buttons and operative convenience. Therefore, it is understandable that doing calculation by a mobile phone is not as easy as by a traditional calculator.

The common design of the functional buttons can be categorized into several types as listed below

The design of the first type of the functional button is called the Multi-tap selection, wherein it uses one single button such as “*” for selecting any operating functions as listed in the following table:

TABLE 1
Multi-tap selection

| Frequency of | | | | | |
|---|---|---|---|---|---|
| pressing buttons | Once | twice | three times | four times | . . . |
| Operating | + | − | × | ÷ | . . . |
| function | | | | | |

However, this operation method results in many problems. For example: First, a user cannot recognize the operating functions immediately. Second, since a user has to select the operating function by repeatedly pressing a particular button, the operating duration will largely depend on the pressing actions and its calculation complexity. The more pressing actions one do, the longer it takes. Thirdly, once any mistake occurs, a user has to spend even more time finding a right one.

The design of the second type of function button is the listed function selection, wherein it uses the left and right buttons to choose the desired operating function, as listed in the table 2:

TABLE 2
Listed function selection

| Buttons | Left button/right button | | | | | | | | |
|---|---|---|---|---|---|---|---|---|---|
| Operating | + | − | × | ÷ | M+ | M− | MR | MC | . . . |
| function | | | | | | | | | |

Apparently, this operational method results in two problems: First, a user has to choose operating function by pressing the left or right buttons. The operating duration will largely depend on the pressing actions and its calculation complexity. Therefore, it takes more time to find the desired function since a single button corresponds to multiple functions. Second, consecutive calculation of addition, subtraction, multiplying or dividing in each operation requires repeatedly pressing the left and right buttons to choose the desired operating functions.

### SUMMARY OF THE INVENTION

It is therefore an objective of the invention to provide a hand-held electronic device having operation keys disposed on the electronic device and operation indicator area on the display. Therefore, a user can perform the operation by pressing the buttons and simultaneously see the corresponding operator indicators shown on the display. Due to the similar arrangement between the operation keys and the operator indicators, the direction of operation keys pressed is exactly the one the highlight shifting along on the operator indicators. The operator indicators are arranged according to the frequency of the operating function being used. The most common use of the operating functions are set in the inner layer of the operation indicators area, and second common use of the operating functions are set in the outer layer of the operation indicators area. At most two pressing action are required for a user to perform the corresponding operating functions. Therefore, this design not only fastens the operation, but also decreases the operational mistakes.

In accordance with the objectives, the invention provides a hand-held electronic device with calculation functions, including a main body, a plurality of number keys disposed on the main body, a display and at least M buttons. A user can input a value by pressing the number keys. The display is used for displaying an operation indicator area, a highlight, and a numeral area. The operation indicator area includes N operator indicators arranged in M directions around a reference point. The N operator indicators correspond to a plurality of operating functions, and wherein M, and N are positive integers equal to or greater than 2, and N is both equal to or greater than M. The highlight is used to indicate the selected operator indicators. The numeral area is used to display the input value and a result value. The M operation keys correspond to the M directions of the operator indicators respectively. When a user presses one of the M operation keys, the highlight shifts along the corresponding direction to choose one of the operator indicators to perform the operating function corresponding to the selected operator indicators. After the operating functions are performed, the result value is obtained and displayed on the display.

It is another objective of the present invention to provide a method of performing calculation functions in the mobile phone. The mobile phone includes a plurality of number keys, a display and M operation keys. The display is used for displaying N operator indicators, a highlight and a numeral area. The N operator indicators arranged in M directions around the a reference point, and the highlight is used for indicating the selected operator indicators, wherein M, and N are positive integers equal to or greater than 2 and N is equal to or greater than M. M functional buttons correspond to M directions and the N operator indicators correspond to a plurality of operating functions. The calculation methods include: when one of the M operation keys is triggered, the highlight shifts along the corresponding direction of the operation keys to one of the N operator indicators for performing the corresponding operating functions of the selected operator indicators. Another method is that after performing at least one operating function for the inputted K numbers, the result value is obtained and displayed on the display.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a front view illustrating hand-held electronic device with calculation function according to the preferred embodiment of the present invention.

FIG. 2 is a flow chart illustrating the method of operating calculation function in the usage of the mobile phone according to the preferred embodiment of the present invention.

FIG. 3 is the first operational example of performing calculation function according to the preferred embodiment of the present invention.

FIG. 4 is the second operational example of performing calculation function according to the preferred embodiment of the present invention.

FIG. 5 is the third operational example of performing calculation function according to the preferred embodiment of the present invention.

FIG. 6 is the fourth operational example of performing calculation function according to the preferred embodiment of the present invention.

### DETAILED DESCRIPTION OF THE INVENTION

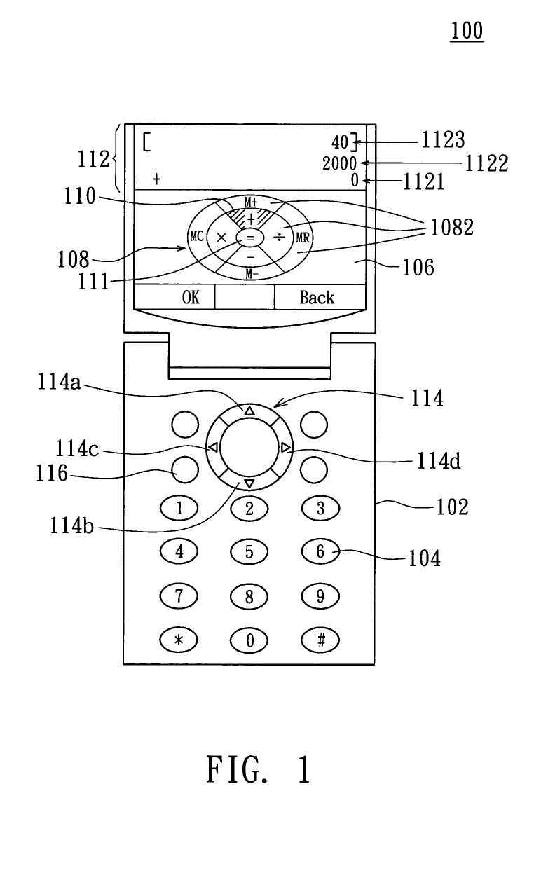

Referring to FIG. 1, a front view of the hand-held electronic device with operating functions according to the preferred embodiment of the present invention is illustrated. The hand-held electronic device, preferably a mobile phone 100, includes a main body, such as a mobile phone body 102, several number keys 104, a display 106 and at least M operation keys.

The number keys 104 are disposed on the mobile phone body 102. At least one value is inputted through the number keys 104. The display 106 is disposed on the mobile phone body 102. The display 106 at least includes an operation indicators area 108 and a numeral area 112.

The operation indicator area 108 includes a reference point and N operator indicators 111 respectively corresponding to N operators. The N operator indicators 111 are arranged in one or more than one layers along M directions of the reference point. The reference point can be an “equal” sign indicator 111. Moreover, the selected operator indicator is indicated by a highlight 110 while operating the operating functions.

M and N are both positive integers equal to or greater than 2. Preferably, M is equal to 4 and N is equal to 8. The operation indicator area comprises 2 layers and each layer comprises 4 operator indicators 1082 around the equal sign indicator 111. In the following paragraphs, an example of M equals to 4 and N equals to 8 is taken for further description.

The operator indicators 1082 include the first layer and the second layer. The first layer adjacent to the equal sign indicator 111 includes 4 general operator indicators, such as plus sign (+) , minus sign (−), multiplying sign (×)and dividing sign (÷). The second layer includes 4 memory operator indicators, including memory operator indicators M+, M−, MC and MR.

Preferably, the plus sign (+) and the memory operator indicator M+ are at the upper part of the operator indicators 1082; the minus sign (−) and the memory operator indicator M− are at the lower part of the operator indicators 1082; the multiplying sign (×) and the memory operator indicator MC are at the left part of the operator indicators 1082, and the dividing sign (÷) and the memory operator indicator MR are at the right part of the operator indicators 1082.

The highlight 110 is used to indicate the selected operator indicators 1082. The numeral area 112 functions as displaying the inputted at least one value and a result value. The M operation keys are disposed on the mobile phone main body 102 in four directions of the operator indicators. For example, direction keys 114a, 114b, 114c, and 114d stand for the up, down, left and right directions, respectively. When a user presses one of the operation keys, highlight shifts along the up, down, left and right directions until pointing at the selected operator indicators 1082. The corresponding operating function of the selected operator indicators 1082 is then performed. Finally, the result value is obtained and displayed on the display.

When one of the operation keys is pressed, the highlight 110 shifts between the operator indicators 1082 other than the equal sign indicator 111 along the corresponding directions. After a single operation is completed, the highlight 110 will automatically return to the equal sign 111.

The arrangement and number of the direction keys 114 are substantially identical to those of the corresponding layer of the operator indicators 1082. For example, the number and arrangement of the general operator indicators “+”, “−”, “×” and “÷” on the first layer of the operator indicators 108 are identical to those of the corresponding direction keys 114a, 114b, 114c and 114d. The number and arrangement of the memory operator indicators M+, M−, MC and MR on the second layer of the operation indicator area 108 are identical to those of the corresponding direction keys 114a, 114b, 114c and 114d.

Furthermore, the direction keys 114 has substantially similar locational relationship with the corresponding operator indicators 1082. For example, the direction key 114d is set at the right side of all the direction keys 114; and the corresponding operator indicators 1082, the general operator indicator “÷” and memory operator indicator MR, are set at the right side of equal sign indicator 111. Users can further understand the operational state with reference to another design shown in FIG. 1. When a general operator indicator is highlighted by the highlight 110, the corresponding operators will be synchronously displayed in the numeral area 112. In FIG. 1, an example of operating “+” is shown for better understanding of the oncoming operation.

Also, by arranging the most commonly used general operator indicators “+”, “−”, “×” and “÷” on the first layer of the operation indicator area 108, only one pressing action of the direction keys 114 can easily perform the corresponding operating functions. The arrangement between the direction keys 114 and the operator indicators 1082 enables a user to operate the direction keys 114 and simultaneously see the corresponding indicators 1082. Due to the similar locational relationship between the direction keys 114 and the operator indicators 1082, the direction corresponding to the pressed direction keys 114 is the one the highlight 110 shifting along on the operator indicators 1082. Therefore, a user can easily perform the operation without making a mistake.

Besides, a user can check the calculation process by directly looking at the numeral area 112. The numeral area 112 includes the first numeral area 1121, the second numeral area 1122, and the third numeral area 1123. The first numeral area 1121 displays the current value to operate. The second numeral area 1122 displays either the previous value or a result value. The third numeral area 1123 displays a memory value.

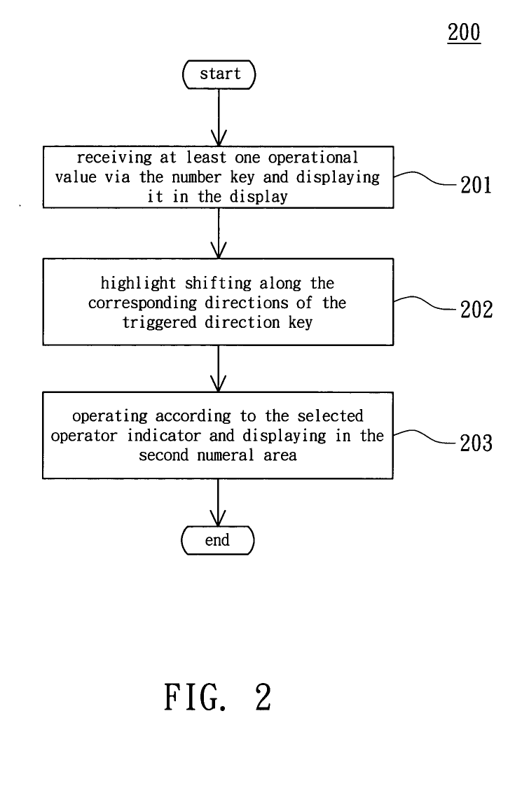

The meaning and functions of the foregoing current value, previous value, result value and memory value are further explained as follows. Referring to FIG. 2, the flow chart of the operational function in the mobile phone according to the preferred embodiment of the present invention is illustrated. Here, M=4 and N=8 are taken as an example for further illustrating but the scope of the invention is not limited thereto.

The flow chart 200 according to a preferred embodiment of the invention includes three main steps.

In the first step 201, at least one operational value is inputted into the mobile phone 100 via the number keys 104. The value is then displayed in the display 106. For example, the first numeral area 1121 displays at least one current value.

In the second step 202, when one of the direction keys 114 is triggered, the highlight 110 shifts along the corresponding directions of the pressed direction keys 114 to one of the eight operator indicators 1082.

In the third step 203, the inputted value is operated according to the selected operator indicator 1082. The result value is displayed in the second numeral area 1122 of the display 106.

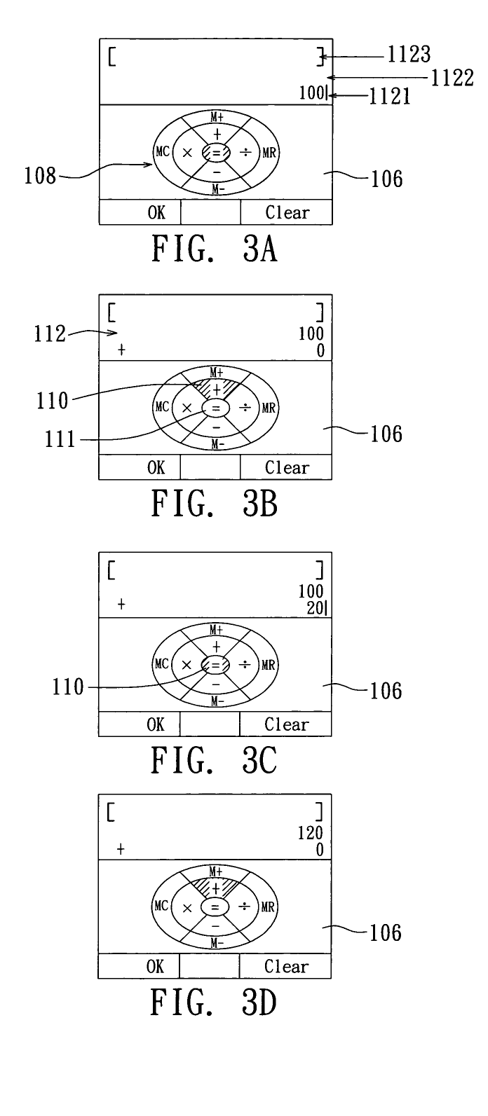

The practical operational flow paths are illustrated in FIG. 3A to FIG. 3D according to the first operational example of the preferred embodiment of the present invention. As shown in FIG. 3A, when inputting value 100, the number 100 will be a current value to operate, displayed on the numeral area 1121 of the display 106. When the highlight 110 shifts to the general operator indicator “+”, the current value becomes zero, and the previously inputted number 100 will be displayed on the second numeral area 1122. Moreover, the numeral area 112 will display an operator “+” and the general operator indicator “+” will be highlighted. Next, when inputting the number 20, “20” will be displayed in the first numeral area 1121 as a current value 20, as shown in FIG. 3C. And then, the highlight 110 automatically goes back to the equal sign indicator 111. When the highlight 110 again shifts to general operator indicator “+”, the current value becomes zero again and the second numeral area 1122 displays the result value, the operated number 120, as shown in FIG. 3C.

There are at least four characteristics in the present invention as follows. First, whenever the number inputted after inserting the operators +, −, ×, and ÷, the highlight 110 will automatically return to the equal sign indicator 111 for the convenience of continuous addition, subtraction, multiplying, and dividing.

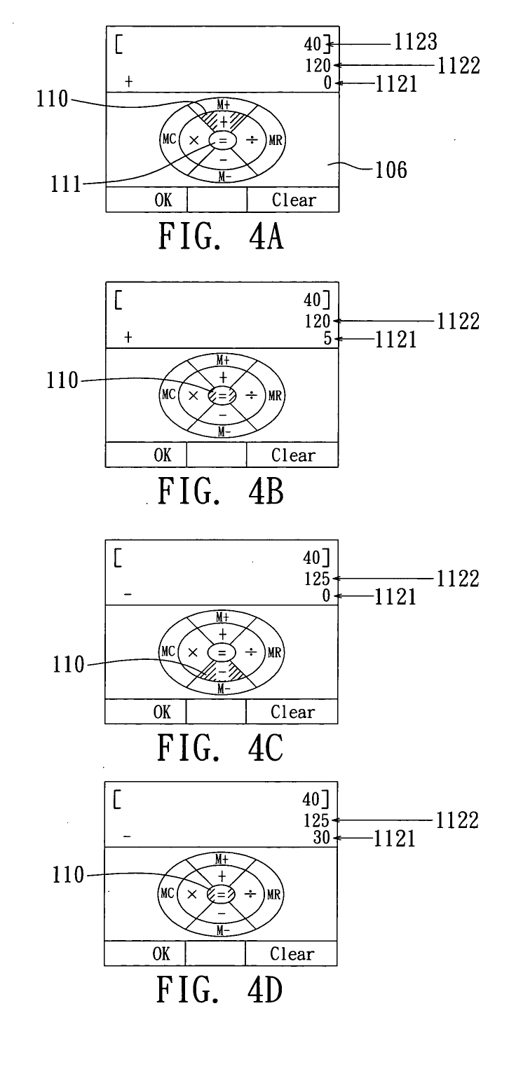

FIG. 4A to FIG. 4D shows the second operational example of the operational calculation functions according to the preferred embodiment of the present invention. As shown in FIG. 4A, the highlight 110 is at the general operator indicator “+”; the first numeral area 1121 displays current value 0; the second numeral area 1122 displays previous value 120; and the third numeral area 1123 displays memory value 40. When the number 5 is input, as shown in FIG. 4B, the highlight 110 will automatically return to the equal sign indicator 111. Next, when the highlight 110 shifts to the general operator indicator “−”, the current value returns to zero again, and the result value 125 is displayed on the second numeral area 1122, as shown in FIG. 4C. When inputting the number 30 into the first numeral area 1121, as shown in FIG. 4D, the highlight 110 will shift back to the equal sign indicator 111 again. In other word, when the highlight 110 is located at one of the general operator indicators and after the mobile phone 100 receives the inputted numbers, the highlight 110 automatically goes back to the equal sign indicator 111.

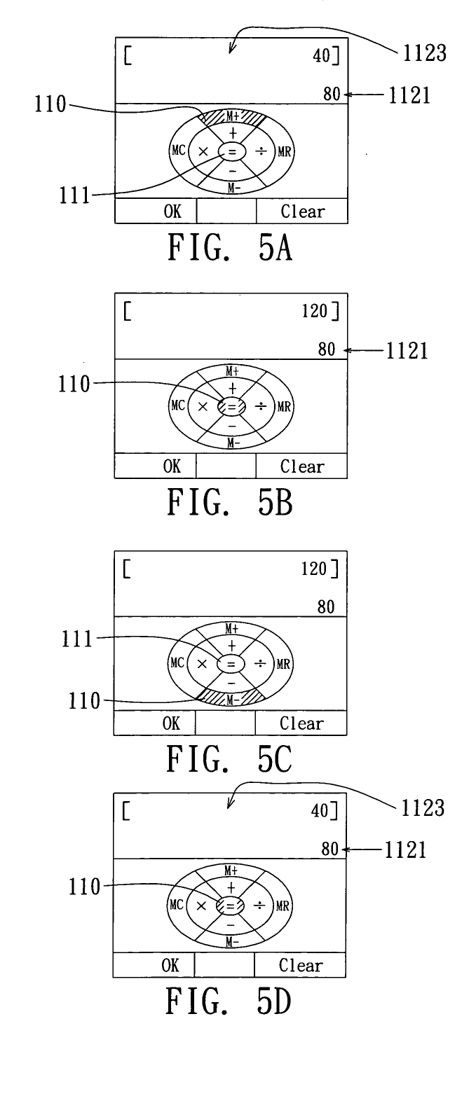

The second characteristic is that after each memory operation, the highlight 110 will automatically return to the equal sign indicator 111 to perform the follow-up operations. Referring to FIG. 5A to FIG. 5D, the third operational example of the operational functions according to the preferred embodiment of the present invention is illustrated.

As shown in the FIG. 5A, the highlight 110 shifts to the memory operator indicator M+. Initially, on the display 106, the first numeral area 1121 displays current value “80” and the third numeral area 1123 displays the memory value “40.” When the confirmation key 116 is pressed, the memory operation is preformed and the memory number of the third numeral area 1123 is renewed as “120.” The highlight 110 then automatically returns to the equal sign indicator 111, as shown in FIG. 5B. And then, as shown in FIG. 5C, the highlight 110 shifts to the memory operator indicator M−. While the confirmation key is pressed, as shown in FIG. 5D, the memory operation is performed again, the memory number of the third numeral area 1123 is renewed as “40” and then the highlight 110 automatically returns to the equal sign indicator 111 again.

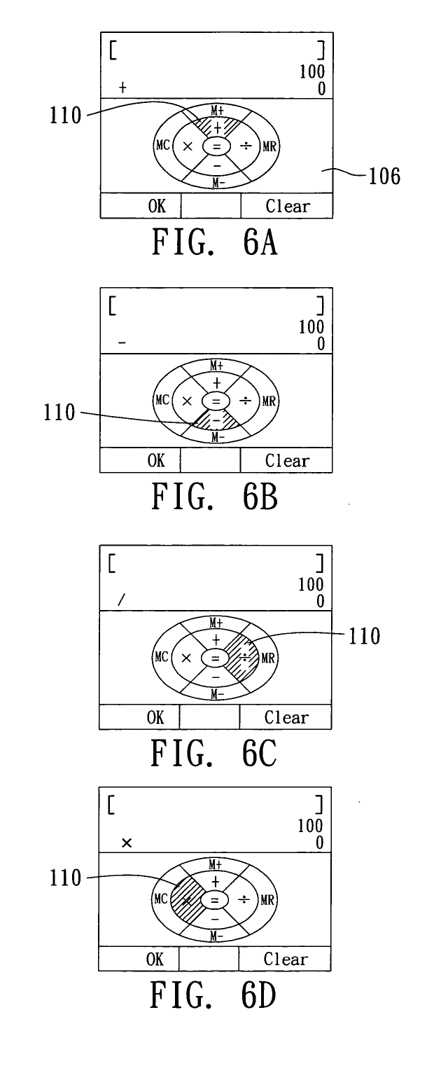

The third characteristic is that when one of the direction keys 114 is selectively pressed, the highlight 110 will skip the equal sign indicator 111. Referring to FIG. 6A to FIG. 6D, the fourth operational example of the operational functions according to the preferred embodiment of the present invention is illustrated.

When a user presses the direction keys 114a, 114b, 114d, and 114c, representing up, down, right and left directions, the highlight 110 will skip the equal sign indicator 111 and allow the general operator indicators “+”, “−”, “÷” and “×” being selected more efficiently. That is to say, with only one pressing action, the highlight can quickly shift to the desired general operator indicators “+”, “−”, “÷” and “×” to perform the corresponding operation. If one wishes to perform memory operations, it merely required two pressing actions to quickly shift the highlight to the desired memory operator indicators “M+”, “M−”, “MC” and “MR”.

Furthermore, mis-pressing can be corrected by minimum pressing actions. For example, instead of the desired “M+”, while “+” is mis-pressed, after double pressing the direction key 114a, the highlight 110 will shift to the memory operator indicator “M+.” Hence, it is more convenient for a user to correct the mistake and perform the operation.

The fourth characteristic is the display of the memory numbers and the reducing of the memory-related operations. Taking the direction key 114 as an example, the memory-related operation (M+, M−, MR, MC) can be easily performed by two pressing actions to shift the highlight 110 to the corresponding operator indicator. Moreover, the memory numbers can be displayed on the third numeral area 1123. As a result, the unnecessary operations should be reduced.

Because of the multi-convenience design of the hand-held electronic device with operating functions according to the preferred embodiment of the present invention, the pressing actions are reduced as well as the operational time. For example, first, as numbers are inputted after inputting the operators (+,−,×,÷) or after performing each memory numbers operation, the highlight is able to return to the equal sign indicator. Second, as the operation keys are selectively pressed, the highlight will skip the equal sign indicator. Third, the memory numbers are displayed and the steps of the memory-related operations are reduced. Therefore, a fast operation and fast completion of the operation can be obtained according to the present invention.

While the invention has been described by way of example and in term s of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A hand-held electronic device with a plurality of operating functions, comprising:
a main body;
a plurality of number keys, disposed on the main body, for inputting at least one value;
a display, connected to the main body, the display displaying:
an operation indicator area having N operator indicators respectively corresponding to N operators, the N operator indicators being arranged in one or more than one layers along M directions of a reference point, wherein M and N are both positive integers equal to or greater than 2 and the operator indicator is indicated by a highlight while the corresponding one of the operating functions is operated; and
a numeral area for displaying the value and a result value; and
at least M operation keys, disposed on the main body, respectively corresponding to the M directions, wherein when one of the M operation keys is triggered, the highlight shifts along a corresponding direction to select one of the N operator indicators to perform the corresponding operating functions to obtain the result value, the result value is displayed in the display.

2. The hand-held electronic device as claimed in claim 1, wherein the M operation keys are M direction keys.

3. The hand-held electronic device as claimed in claim 1, while at least one of the M operation keys is triggered, the highlight shifts between the N operator indicators expect the reference point, along the corresponding direction of the operation keys.

4. The hand-held electronic device as claimed in claim 1, wherein the highlight automatically returns to the reference point when completing one of the operating functions.

5. The hand-held electronic device as claimed in claim 1, wherein M is 4, the operator indicators are arranged in P layers and each layer comprises 4 operator indicators around the reference point.

6. The hand-held electronic device as claimed in claim 5, wherein P is 2 and the operator indicators have a first layer and a second layer, the operator indicators comprises 4 general operator indicators in the first layer and 4 memory operator indicators in the second layer, the operator indicators of the first layer are adjacent to the reference point.

7. The hand-held electronic device as claimed in claim 6, wherein when one of the general operator indicators is selected, an operator corresponding to the general operator indicators is displayed on the numeral area.

8. The hand-held electronic device as claimed in claim 1, wherein the numeral area comprises a first numeral area displaying a current value to operate and a second numeral area displaying either a previous value or the result value.

9. The hand-held electronic device as claimed in claim 1, wherein the numeral area comprises a third numeral area for displaying a memory value.

10. The hand-held electronic device as claimed in claim 1, wherein the hand-held electronic device is a mobile phone.

11. A method of performing a plurality of operating functions in a hand-held electronic device, the hand-held electronic device comprising a plurality of number keys, a display and M operation keys, the display displaying N operator indicators, a highlight, and a numeral area, the N operator indicators being arranged in one or more than one layers along M directions of a reference point, wherein M, and N both being positive integers equal to or greater than 2, the operator indicator being indicated by a highlight while the corresponding one of the operating functions is operated, the M operation keys respectively corresponding to the M directions, and the N operator indicators respectively corresponding to N operators, the methods comprising:
receiving at least one operation value through the number keys and displaying the at least one operation value on the display;
shifting the highlight between one of the operator indicators along a direction corresponding to the operation keys to perform an operating function corresponding to the operator indicators while at least one of the M operation keys is triggered; and
operating the operation value according to the corresponding operation function of the operator indicator to generate a result value, the result value being displayed on the display.

12. The method as claimed in claim 11, wherein the highlight automatically returns to the reference point when completing one of the operating functions.

13. The method as claimed in claim 11, wherein the M operation keys are M direction keys.

14. The method as claimed in claim 11, while at least one of the M operation keys is triggered, the highlight shifts between the N operator indicators, expect the reference point, along a corresponding direction of the operation keys.

15. The method as claimed in claim 11, wherein M is 4, the operator indicators are arranged in P layers and each layer comprises 4 operator indicators around the reference point.

16. The method as claimed in claim 15, wherein P is 2 and the operator indicators have a first layer and a second layer, the operator indicators comprises 4 general operator indicators in the first layer and 4 memory operator indicators in the second layer, the operator indicators of the first layer are adjacent to the reference point.

17. The method as claimed in claim 11, wherein the hand-held electronic device is a mobile phone.
